(19) United States
(12) Patent Application Publication
(10) Pub. No.: US 2009/0285511 A1
(43) Pub. Date: Nov. 19, 2009

(54) Cross Direction Tear Film and Package

(75) Inventor: Dinesh Aithani, Williamsburg, VA (US)

Correspondence Address: MCANDREWS HELD & MALLOY, LTD, 500 WEST MADISON STREET, SUITE 3400, CHICAGO, IL, 60661, US

(73) Assignee: PLIANT CORPORATION, Chippewa Falls, WI (US)

(21) Appl. No.: 12/510,406

(22) Filed: Jul. 28, 2009

Related U.S. Application Data
(63) Continuation of application No. 12/400,432, filed on Mar. 9, 2009, now abandoned.
(60) Provisional application No. 61/034,824, filed on Mar. 7, 2008.

(51) Int. Cl. B65D 33/00; C08F 210/00; C08L 23/04; C08L 23/00; C08L 33/10; B32B 7/12; B32B 27/08; B32B 27/36

(52) U.S. Cl. 383/200; 526/348; 525/240; 525/227; 428/516; 428/343; 525/57; 428/483

(57) ABSTRACT

A film having a cross directional tear/machine directional tear ratio below 1 is described. The film has a sealant layer with a cyclic olefin copolymer. The film can be used in the manufacture of packages having an easy cross-direction tear open feature. There are also provided methods for the production of the film and packages made of the film.

### RELATED APPLICATIONS

This patent application is a continuation of U.S. application Ser. No. 12/400,432, filed on Mar. 9, 2009, which patent application makes reference to, claims priority to and claims benefit from U.S. Provisional Patent Application Ser. No. 61/034,824, filed on Mar. 7, 2008 and which are incorporated hereby in their entireties.

### FEDERALLY SPONSORED RESEARCH OR DEVELOPMENT

[Not Applicable]

### MICROFICHE/COPYRIGHT REFERENCE

[Not Applicable]

### TECHNICAL FIELD

The invention relates to films, and in particular to films having easy cross-directional tear properties, as well as packages made from such films.

### BACKGROUND OF THE INVENTION

Certain techniques have been proposed to control the tear properties of films, such as those described in US Patent Application 20020068668, and U.S. Pat. Nos. 7,052,750, and 5,786,050.

### BRIEF SUMMARY OF THE INVENTION

An aspect of the present invention is a film having a sealant layer having a cyclic olefin copolymer. The film has a cross directional tear/machine directional tear ratio below 1.

Another aspect of the invention is a package made from a film as described in the preceding paragraph.

A still further aspect of the present invention is a method for producing a film as described in the second preceding paragraph.

### BRIEF DESCRIPTION OF SEVERAL VIEWS OF THE DRAWINGS

FIG. 1 is a rear elevation view of an embodiment that is a pillow pouch.

FIG. 2 is a rear elevation view of the opened package of FIG. 1 illustrating the easy CD tear property of the package.

FIG. 3 is a view similar to FIG. 1 of another embodiment 20 having a modified fin-seal having a notch to direct CD tear opening of the package.

FIG. 4 is a rear elevation view of the opened package of FIG. 3 illustrating the easy CD tear property of the package.

FIG. 5 is an elevation view of an embodiment that is a four sided seal pouch.

FIG. 6 is a sectional view taken along the section lines 6-6 of FIG. 5.

FIG. 7 is a sectional view taken along the section line 7-7 of FIG. 6.

FIG. 8 is a cross-section of another embodiment, showing a three-layer film.

### DETAILED DESCRIPTION OF THE INVENTION

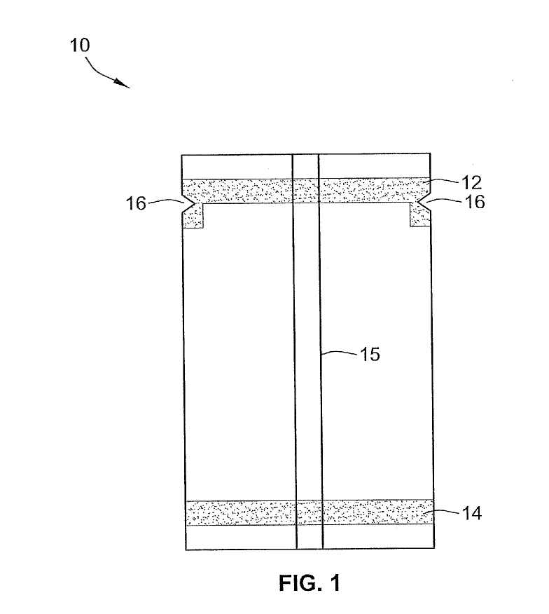

FIG. 1 shows an embodiment of a package 10 that is a pillow pouch. The package 10 has a top-seal 12, a bottom-seal 14, and a fin-seal 15. As used herein the phrase “seal” refers to any joint of a first region of a film surface to a second region of a film surface. In some embodiments the joints are fluid-impervious, but this is not an essential feature.

The package 10 can also have one or more tear notches 16. For example the package can have a modified top-seal 12 having a notch 16 at one or both sides. The notch 16 can be in any one or more positions on the package, including any one or more seal areas. The notch 16 does not affect the seal integrity of the package, and is used as a starting point to tear open the package. In an embodiment, tear notches are located on one or both side seals.

Packages according to the present invention have a machine-direction and a cross-direction. As used herein the phrase “machine direction”, herein abbreviated “MD”, refers to a direction along the length of the film, or in the direction the film is formed or fabricated into packages. As used herein the phrase “cross-direction”, herein abbreviated “CD”, refers to a direction across the film, or perpendicular to the MD. In the embodiment according to FIG. 1, the fin seal 15 commonly runs in the machine direction and the end seals 12 and 14 commonly run in the cross-direction though that arrangement is not critical.

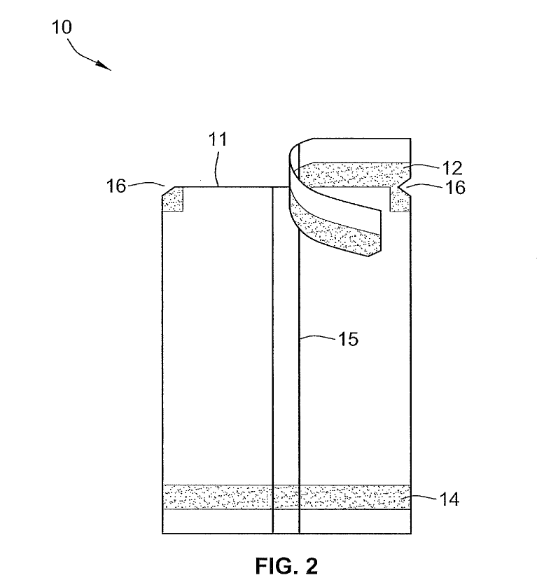

The package of FIGS. 1 and 2 is a CD tear package having an easy CD tear property. FIG. 2 is an illustration demonstrating the easy CD tear property of a package 10 according to the present invention. As shown, a tear 11 is started at one of the notches 16 of the modified top-seal 12, and more easily propagates in the CD than the MD.

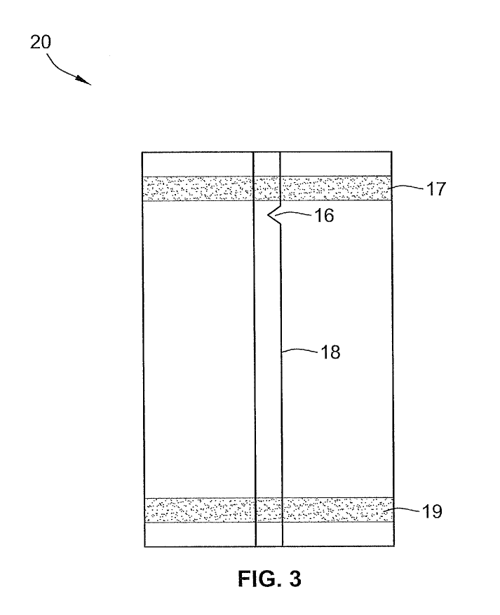

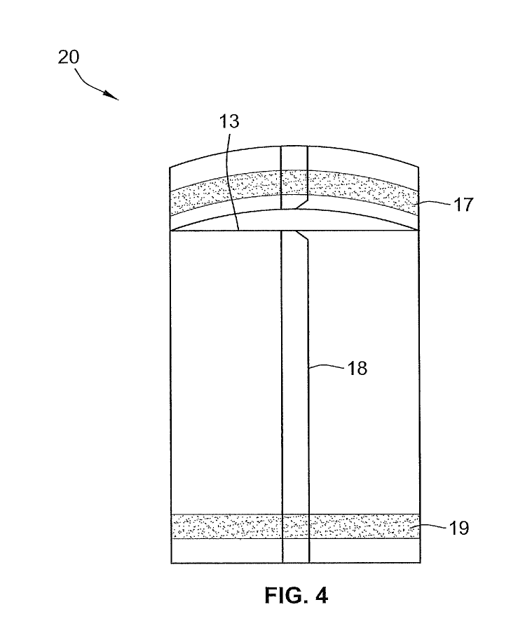

FIGS. 3 and 4 show another package 20 that is also a pillow pouch, The package 20 has a top-seal 17, a bottom seal 19, and a fin-seal 18 having a notch 16 (FIG. 3) that can be used as a starting point to tear open the package. FIG. 4 is an illustration demonstrating the easy CD tear property of the package 20. As shown, a tear 13 is started at the notch 16 on the fin-seal 18, and easily propagates in the CD across the package in both directions.

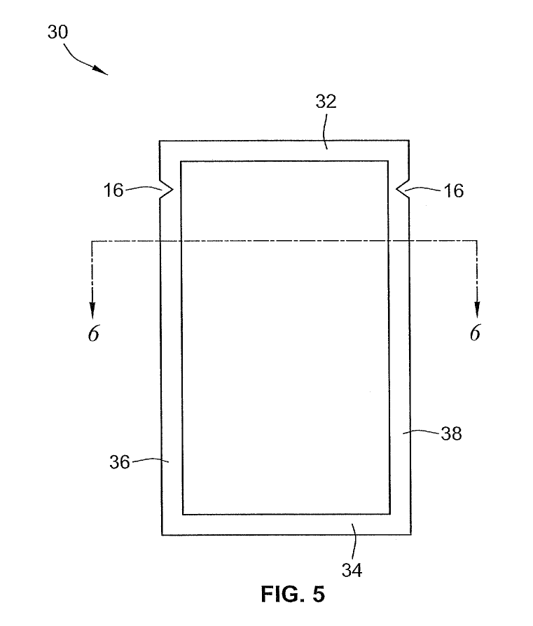

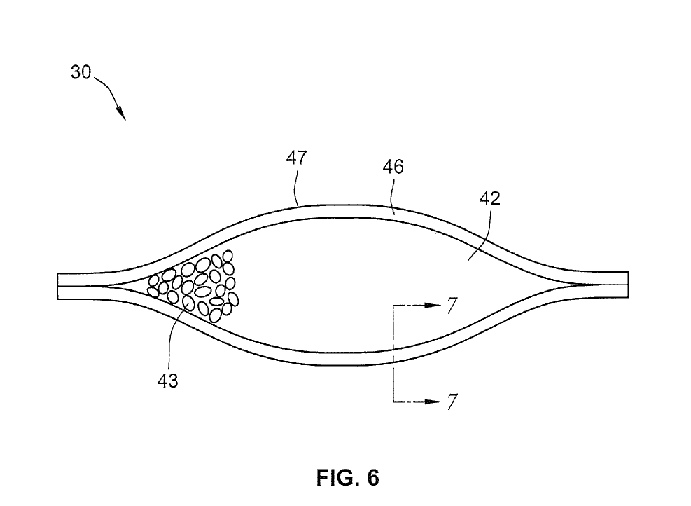

FIGS. 5-6 show another embodiment of a package 30 that is a four sided seal pouch, having a top seal 32, a bottom seal 34, a side seal 36 and a side seal 38. The package 30 has a notch 16 on one or both side-seals 36 and 38 that can be used as a starting point to tear open the package 30 in the CD.

FIG. 6 is a sectional view taken along the section lines 6-6 of FIG. 5 showing the interior 42 and contents 43 of the package 30 formed from a film 46 having an inner surface 44 and an outer surface 47. The package 30, and any other packages according to the present invention, have an easy CD tear property and are made using easy CD tear films having a sealant layer having a cyclic olefin copolymer, as described later.

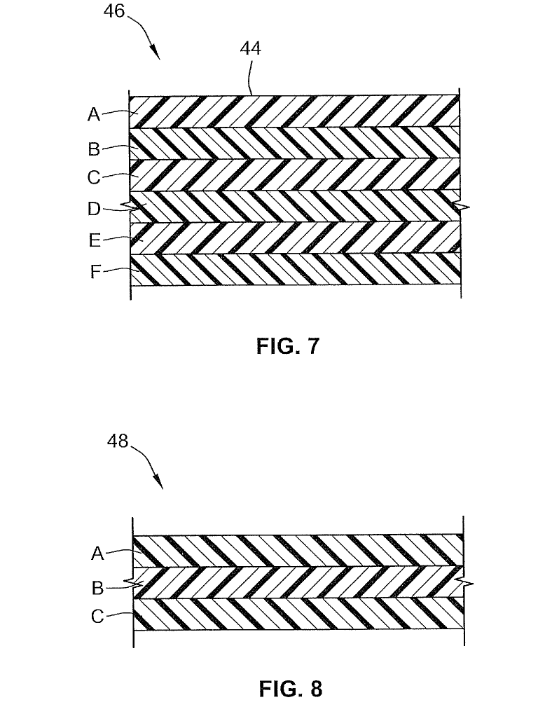

FIG. 7 is a sectional view taken along the section line 7-7 of FIG. 6, and is an illustration of one embodiment of a film 46 having six layers represented by the construction A/B/C/D/E/F, in which A is the inner or sealant layer and F is the outer layer. The film of this embodiment has from 5 to 95 weight percent of a sealant layer A having a cyclic olefin copolymer; from 10-20 weight percent of a layer B having a linear medium density polyethylene, high density polyethylene, or a polyolefin plastomer; from 4 to 12 weight percent of a first tie layer C; from 10-15 weight percent of a layer D having an ethylene vinyl alcohol copolymer or nylon; from 4 to 12 weight percent of a second tie layer E; and from 12-75 weight percent of a layer F having a linear medium density polyethylene or a high density polyethylene polymer.

FIG. 8 is an illustration of another embodiment of a film 48 having three layers represented by the construction A/B/C. The film 48 has from 5 to 95 weight percent of a sealant layer A having a cyclic olefin copolymer; from 10-20 weight percent of a layer B having a polyolefin plastomer; and from 12-75 weight % of a layer C having a high density polyethylene polymer.

The packages according to the present invention can take any shape or design, including for example three-sided or four-sided side-seal pouches, pillow pouches, or stand-up pouches. The package can also be made resealable or reclosable, for example by the use of a ziplock closure or an adhesive coating.

The sealant layer A contains a cyclic olefin copolymer (COC). The phrase cyclic olefin copolymer or “COC” generally refers to a copolymer of norbornene and ethylene. Cyclic olefin copolymers are a class of polymers generally based on cyclic olefin monomers and ethene. There are several types of cyclic olefin copolymers based on different types of cyclic monomers and polymerization methods. Pure Appl. Cem. Vol. 77, No. 5, pp. 801-914, 2005 is incorporated herein by reference to provide a general description of cyclic olefin copolymers. A cyclic olefin copolymer also can be, for example, any of those described in U.S. Pat. No. 7,052,750, col. 1, lines 25-40; U.S. Pat. No. 6,921,563; U.S. Pat. No. 6,068,936; U.S. Pat. No. 5,912,070; U.S. Pat. No. 5,494,969; or U.S. Pat. No. 5,786,050.

The amount of the cyclic olefin copolymer contained within the sealant layer can vary according to the properties desired in the film, including for example the tear properties of the film. For example, the sealant layer according to the present invention can have from 5 to 95 weight percent of a cyclic olefin copolymer, optionally from 5 to 80 weight % of a cyclic olefin copolymer, optionally from 15 to 40 weight % of a cyclic olefin copolymer, optionally at least 10 weight % of a cyclic olefin copolymer, optionally at least 20 weight % of a cyclic olefin copolymer, optionally at least 30 weight % of a cyclic olefin copolymer, and optionally at least 40 weight % of a cyclic olefin copolymer.

The sealant layer according to the present invention can also include one or more additional polymers, such as for example an ethylene polymer or a propylene polymer. In addition to a cyclic olefin copolymer, the sealant layer can also have, for example, a plastomer or ionomer. Suitable polymers added to the sealant layer in addition to the cyclic olefin copolymer include but are not limited to linear low-density polyethylene, linear medium density polyethylene, low-density polyethylene, medium density polyethylene, ethylene vinyl acetate copolymer, ethylene methyl acrylate copolymer, ethylene methyl acrylic acid copolymer, or high density polyethylene.

As used herein, the term “polymer” refers to the product of a polymerization reaction, and is inclusive of homopolymers and copolymers. In general, the layers of a film can have a single polymer, or can have additional polymers together therewith, for example blended therewith.

As used herein, the phrase low density polyethylene (“LDPE”) refers to ethylene homopolymer having a density ranging from about 0.91 g/cm³ to about 0.925 g/cm³. LDPE is typically produced using conventional high pressure process.

As used herein, the phrase linear low density polyethylene (“LLDPE”) refers to ethylene alpha-olefin copolymers having a density ranging from about 0.915 g/cm³ to about 0.94 g/cm³. LLDPE can be manufactured using a conventional Ziegler Natta catalyst or a single site catalyst, such as metallocene.

As used herein, the phrase linear medium density polyethylene (“LMDPE”) refers to ethylene alpha-olefin copolymers having a density ranging from about 0.925 g/cm³ to about 0.94 g/cm³. LMDPE can be manufactured using conventional Ziegler Natta catalysts or single site catalysts, such as metallocene.

As used herein, the phrase high density polyethylene (“HDPE”) refers to ethylene alpha-olefin copolymers or ethylene homopolymer having a density of about 0.94 g/cm³ or greater. HDPE can be produced with several classes of catalysts, such as Ziegler-Natta catalysts and metallocene catalysts.

The amount of the sealant layer contained within the film may also vary according to the properties desired in the film. For example, the film according to the present invention can be a monolayer having 100 weight % of the sealant layer. Alternatively the film can be a multilayer film having the sealant layer and one or more additional layers in any arrangement and combination of weight percentages. For example, the film can have from 5 to 95 weight % of the sealant layer, optionally from 10 to 90 weight % of the sealant layer, optionally from 10 to 70 weight % of the sealant layer, or optionally from 15 to 40 weight % of the sealant layer in combination with one or more additional layers.

The film can be a multilayer film having one or more additional layers. The additional layers can have one or more polymers, including for example an ethylene or a propylene polymer. Examples of suitable polymers include but are not limited to linear low-density polyethylene, linear medium density polyethylene, low-density polyethylene, medium density polyethylene, ethylene vinyl acetate copolymer, ethylene methyl acrylate copolymer, ethylene methyl acrylic acid copolymer, or high density polyethylene.

The film can have a sealant layer having a cyclic olefin copolymer and from 10-20 weight percent of an additional layer having a linear medium density polyethylene, high density polyethylene, or a polyolefin plastomer.

The film can have a sealant layer having a cyclic olefin copolymer and from 12-75 weight percent of an additional print receivable layer, having for example a linear medium density polyethylene or a high density polyethylene polymer.

The film can have a sealant layer having a cyclic olefin copolymer and from 10-15 weight percent of an additional layer having an ethylene vinyl alcohol copolymer or nylon.

The film can have a sealant layer having a cyclic olefin copolymer and from 4 to 12 weight percent of an additional tie layer having adhesive properties. In certain films, the tie layer can be for example a Bynel tie layer. Bynel is a trademark of E. I. du Pont de Nemours and Company for adhesive resins.

The present film can be laminated to other films or substrates, for example on the non-sealant side. For example, the film can be laminated to polyester, polypropylene, bi-axially oriented nylon, bi-axially oriented polypropylene, or polyethylene films. The present film can be laminated to a substrate with or without surface or reverse printing.

The film can be laminated to other films or substrates using adhesive lamination, extrusion lamination, thermal lamination, or other methods.

The present film can be an easy CD tear film having a CD Elmendorf tear below 90 (gf), optionally below 80 (go, optionally below 60 (go, optionally below 40, or optionally below 20. The film can have a CD Elmendorf tear/MD Elmendorf tear ratio below 1, optionally below 0.8, optionally below 0.6, optionally below 0.4, optionally below 0.2, or optionally below 0.1. The film can have a CD Elmendorf tear/MD Elmendorf tear ratio of from between 0.05 and 0.9, optionally from between 0.05 and 0.7, optionally from between 0.05 and 0.5, optionally from between 0.05 and 0.3, optionally from between 0.05 and 0.3, or optionally from between 0.05 and 0.1.

The film can have an MD ultimate tensile strength of from 3500 N/cm² to 2000 N/cm², and a CD ultimate tensile strength of from 3000 N/cm² to 2000 N/cm². The film can also have a CD ultimate tensile strength 1 MD ultimate tensile strength ratio of from 0.75 and 1.10.

The film can have an MD ultimate elongation of from 90% to 319%, and a CD ultimate elongation of from 5% to 410%. The film can also have a CD ultimate elongation %/MD ultimate elongation % ratio of from 0.05 to 3.5.

The film can have an MD secant modulus of from 100,000 N/cm² to 60,000 N/cm², and a CD secant modulus of from 105,000 N/cm² to 60,000 N/cm². The film can also have a CD secant modulus/MD secant modulus ratio of from 0.70 to 1.2.

### Examples 1-7

Examples 1-6 are multilayer films having the 6 layer construction A/B/C/D/E/F illustrated in FIG. 7. The composition and weight percentage of each layer A/B/C/DIE/F in the film are shown in Tables 1-6 respectively.

Example 7 is a film containing 3 layers, represented by the construction A/B/C illustrated in FIG. 8, wherein the composition and weight percentage of each layer A/B/C in the film are shown in Table 7.

Each of the example films were tested for the following properties: MD and CD Elmendorf tear (gf); MD and CD ultimate tensile (PSI or N/cm²); MD and CD ultimate elongation (%); and MD and CD secant elongation (PSI or N/cm²). The test results for each film, examples 1-7, are shown in Table 8.

As is understood in the art, the Elmendorf tear (gf) of a film can be measured by ASTM D-1922. This test method determines the average force to propagate tearing through a specified length of film after the tear has been started, using an Elmendorf-type tearing tester. As is also understood in the art, the MD and CD ultimate tensile strength, ultimate elongation, or secant modulus of a film can be measured by ASTM D-882. This test method employs a constant rate of separation of the grips holding the ends of the test film. Extension may be measured in these test methods by grip separation, extension indicators, or displacement of gage marks.

The present invention is not limited to a MD/CD tear ratio as determined from Elmendorf tear testing. Any tear strength test method now or later developed can be used.

### Example 1

A sample film was prepared having the six layer construction shown in FIG. 7. The composition and weight % of each layer A/B/C/D/E/F of this film is shown in Table 1. The tear properties of this film are shown in Table 8. It was determined that this film had a CD Elmendorf tear=49 (gf) a MD Elmendorf tear=152 (gf), and a CD Elmendorf tear/MD Elmendorf tear ratio=0.32.

### Example 2

Another sample film was prepared having the six layer construction shown in FIG. 7. The composition and weight % of each layer A/B/C/D/E/F of this film is shown in Table 2. The tear properties of the film are shown in Table 8. It was determined that this film had a CD Elmendorf tear <40 (gf) a MD Elmendorf tear=237 (gf) and a CD Elmendorf tear/MD Elmendorf tear ratio<0.17.

### Example 3

Another sample film was prepared having the six layer construction shown in FIG. 7. The composition and weight % of each layer A/B/C/D/E/F of this film is shown in Table 3. The tear properties of the film are shown in Table 8. It was determined that this film had a CD Elmendorf tear=41 (gf), a MD Elmendorf tear=260 (gf) and a CD Elmendorf tear/MD Elmendorf tear ratio=0.16.

### Example 4

Another sample film was prepared having the six layer construction shown in FIG. 7. The composition and weight % of each layer A/B/C/DIE/F of this film is shown in Table 4. The tear properties of the film are shown in Table 8. It was determined that this film had a CD Elmendorf tear <40 (gf), a MD Elmendorf tear=266 (gf) and a CD Elmendorf tear/MD Elmendorf tear ratio<0.15.

### Example 5

Another sample film was prepared having the six layer construction shown in FIG. 7. The composition and weight % of each layer A/B/C/D/E/F of this film is shown in Table 5, and the tear properties of the film are shown in Table 8. It was determined that this film had a CD Elmendorf tear <40 (gf), a MD Elmendorf tear=440 (gf) and a CD Elmendorf tear/MD Elmendorf tear ratio<0.09.

### Example 6

Another sample film was prepared having the six layer construction shown in FIG. 7. The composition and weight % of each layer A/B/C/D/E/F in this film is shown in Table 6, and the tear properties of the film are shown in Table 8. It was determined that this film had a CD Elmendorf tear=84 (gf), a MD Elmendorf tear=140 (gf), and a CD Elmendorf tear/MD Elmendorf tear ratio=0.6.

### Example 7

Another sample film was prepared having the three layer construction shown in FIG. 8. The composition and weight % of each layer A/B/C in this film is shown in Table 7, and the tear properties of the film are shown in Table 8. It was determined that this film had a CD Elmendorf tear=25 (gf), a MD Elmendorf tear=45 (gf), and a CD Elmendorf tear/MD Elmendorf tear ratio=0.56.

Any of the films according to the present invention can be manufactured using any of those methods known in the art, including but not limited to those methods in which the film is blown or cast.

TABLE 1
(EXAMPLE 1)

| | Weight % of | |
|---|---|---|
| Layer | layer in film | Composition |
| A | 40 wt % | sealant layer having the polyolefin plastomer |
| | | Affinity PF1140 from The Dow Chemical Company |
| | | (hereinafter (“Dow)), containing 15% cyclic olefin |
| | | copolymer |
| B | 12 wt % | layer having Dowlex 2038.68G from Dow, a linear |
| | | medium density polyethylene |
| C | 8 wt % | tie layer having Bynel 4104 from DuPont, a maleic |
| | | anhydride modified linear low-density polyethylene |
| D | 12 wt % | layer having Soarnol DC3203F from Soarus, an |
| | | ethylene vinyl alcohol copolymer with 32 mol % |
| | | ethylene content. |
| E | 8 wt % | tie layer having Bynel 4104 from DuPont, a maleic |
| | | anhydride modified linear low-density polyethylene |
| F | 20 wt % | layer having Dowlex 2038.68G from Dow, a linear |
| | | medium density polyethylene |

TABLE 2
(EXAMPLE 2)

| | Weight % of | |
|---|---|---|
| Layer | layer in film | Composition |
| A | 40 wt % | sealant layer having the polyolefin plastomer |
| | | Affinity PF1140 from Dow, containing 25% cyclic |
| | | olefin copolymer |
| B | 12 wt % | layer having Dowlex 2038.68G from Dow, a linear |
| | | medium density polyethylene |
| C | 8 wt % | tie layer having Bynel 4104 from DuPont, a maleic |
| | | anhydride modified linear low-density polyethylene |
| D | 12 wt % | layer having Soarnol DC3203F from Soarus, an |
| | | ethylene vinyl alcohol copolymer with 32 mol % |
| | | ethylene content. |
| E | 8 wt % | tie layer having Bynel 4104 from DuPont, a maleic |
| | | anhydride modified linear low-density polyethylene |
| F | 20 wt % | layer having Dowlex 2038.68G from Dow, a linear |
| | | medium density polyethylene |

TABLE 3
(EXAMPLE 3)

| | Weight % of | |
|---|---|---|
| Layer | layer in film | Composition |
| A | 28 wt % | sealant layer having the ionomer |
| | | Surlyn ® 1652SB from DuPont, containing 15% |
| | | cyclic olefin copolymer |
| B | 20 wt % | layer having Dowlex 2038.68G from Dow, a linear |
| | | medium density polyethylene |
| C | 8 wt % | tie layer having Bynel 4104 from DuPont, a maleic |
| | | anhydride modified linear low-density polyethylene |
| D | 12 wt % | layer having Soarnol DC3203F from Soarus, an |
| | | ethylene vinyl alcohol copolymer with 32 mol % |
| | | ethylene content. |
| E | 7 wt % | tie layer having Bynel 4104 from DuPont, a maleic |
| | | anhydride modified linear low-density polyethylene |
| F | 25 wt % | layer having Dowlex 2038.68G from Dow, a linear |
| | | medium density polyethylene |

TABLE 4
(EXAMPLE 4)

| | Weight % of | |
|---|---|---|
| Layer | layer in film | Composition |
| A | 25 wt % | sealant layer having the polyolefin plastomer |
| | | Affinity PF1140 from Dow, containing 25% cyclic |
| | | olefin copolymer |
| B | 20 wt % | layer having Dowlex 2038.68G from Dow, a linear |
| | | medium density polyethylene |
| C | 8 wt % | tie layer having Bynel 4104 from DuPont, a maleic |
| | | anhydride modified linear low-density polyethylene |
| D | 12 wt % | layer having Soarnol DC3203F from Soarus, an |
| | | ethylene vinyl alcohol copolymer with 32 mol % |
| | | ethylene content. |
| E | 8 wt % | tie layer having Bynel 4104 from DuPont, a maleic |
| | | anhydride modified linear low-density polyethylene |
| F | 27 wt % | layer having Dowlex 2038.68G from Dow, a linear |
| | | medium density polyethylene |

TABLE 5
(EXAMPLE 5)

| | Weight % of | |
|---|---|---|
| Layer | layer in film | Composition |
| A | 40 wt % | sealant layer having the polyolefin plastomer |
| | | Affinity PF1140 from Dow, containing 25% cyclic |
| | | olefin copolymer |
| B | 12 wt % | layer having MarFlex 9659 from Chevron Phillips, a |
| | | high density polyethylene polymer |
| C | 8 wt % | tie layer having Bynel 4104 from DuPont, a maleic |
| | | anhydride modified linear low-density polyethylene |
| D | 12 wt % | layer having Soarnol DC3203F from Soarus an |
| | | ethylene vinyl alcohol copolymer with 32 mol % |
| | | ethylene content. |
| E | 8 wt % | tie layer having Bynel 4104 from DuPont, a maleic |
| | | anhydride modified linear low-density polyethylene |
| F | 20 wt % | layer having MarFlex 9659 from Chevron Phillips, a |
| | | high density polyethylene polymer |

TABLE 6
(EXAMPLE 6)

| | Weight % of | |
|---|---|---|
| Layer | layer in film | Composition |
| A | 40 wt % | sealant layer having the polyolefin plastomer |
| | | Affinity PF1140 from Dow, containing 25% cyclic |
| | | olefin copolymer |
| B | 12 wt % | layer having Marflex 9659 from Chevron Phillips, a |
| | | high density polyethylene polymer |
| C | 8 wt % | tie layer having Bynel 4104 from DuPont, a maleic |
| | | anhydride modified linear low-density polyethylene |
| D | 12 wt % | layer having UBE Nylon 5033B, a nylon 6/66 resin |
| | | (available from UBE) |
| E | 8 wt % | tie layer having Bynel 4104 from DuPont, a maleic |
| | | anhydride modified linear low-density polyethylene |
| F | 20 wt % | layer having MarFlex 9659 from Chevron Phillips, a |
| | | high density polyethylene polymer |

TABLE 7
(EXAMPLE 7)

| | Weight % of | |
|---|---|---|
| Layer | layer in film | Composition |
| A | 15 wt % | sealant layer having the polyolefin plastomer |
| | | Affinity PF1140 from Dow, containing 40% cyclic |
| | | olefin copolymer |
| B | 10 wt % | layer having the polyolefin plastomer Affinity |
| | | PF1140 from Dow |
| C | 75 wt % | layer having MarFlex 9659 from Chevron Phillips a |
| | | high density polyethylene polymer |

TABLE 8

| | Example | | | | | | |
|---|---|---|---|---|---|---|---|
| | 1 | 2 | 3 | 4 | 5 | 6 | 7 |
| MD, Elmendorf | 152 | 237 | 260 | 266 | 440 | 140 | 45 |
| tear (gf) | | | | | | | |
| CD, Elmendorf | 49 | <40 | 41 | <40 | <40 | 84 | 25 |
| tear (gf) | | | | | | | |
| MD, Ultimate | 4003 | 4371 | 3644 | 4036 | 4805 | 3926 | 3406 |
| Tensile | (2760) | (3014) | (2514) | (2783) | (3313) | (2707) | (2348) |
| PSI (N/cm²) | | | | | | | |
| CD, Ultimate | 3423 | 4047 | 3551 | 3724 | 3645 | 3990 | 3541 |
| Tensile, | (2360) | (2790) | (2448) | (2568) | (2513) | (2751) | (2442) |
| PSI (N/cm²) | | | | | | | |
| MD, Ultimate | 120 | 124 | 303 | 127 | 145 | 119 | 98 |
| Elongation (%) | | | | | | | |
| CD, Ultimate | 327 | 363 | 343 | 323 | 336 | 408 | 7 |
| Elongation (%) | | | | | | | |
| MD, 1% | 104704 | 120786 | 99366 | 130517 | 143229 | 97607 | 130700 |
| Secant | (72193) | (83282) | (68513) | (89991) | (98756) | (67300) | (90118) |
| modulus | | | | | | | |
| PSI (N/cm²) | | | | | | | |
| CD, 1% | 88920 | 90964 | 105703 | 121857 | 133984 | 93207 | 151913 |
| Secant | (61310) | (62720) | (72882) | (84020) | (92382) | (64266) | (104744) |
| modulus | | | | | | | |
| PSI (N/cm²) | | | | | | | |

1. A film comprising a sealant layer comprising a cyclic olefin copolymer, the film having a cross directional tear/machine directional tear ratio below 1.

2. The film of claim 1, wherein said ratio is between 0.05 and 0.9.

3. The film of claim 1, wherein said ratio is between 0.05 and 0.7.

4. The film of claim 1, wherein said ratio is between 0.05 and 0.5.

5. The film of claim 1, wherein said ratio is between 0.05 and 0.3.

6. The film of claim 1, wherein said ratio is between 0.05 and 0.1.

7. The film of claim 1, wherein said sealant layer comprises 5 to 95 weight % of a cyclic olefin copolymer.

8. The film of claim 1, wherein said sealant layer comprises 5 to 80 weight % of a cyclic olefin copolymer.

9. The film of claim 1, wherein said sealant layer comprises 15 to 40 weight % of a cyclic olefin copolymer.

10. The film of claim 1, wherein said sealant layer comprises at least 10 weight % of a cyclic olefin copolymer.

11. The film of claim 1 wherein said sealant layer comprises at least 20 weight % of a cyclic olefin copolymer.

12. The film of claim 1 wherein said sealant layer comprises at least 30 weight % of a cyclic olefin copolymer.

13. The film of claim 1 wherein said sealant layer comprises at least 40 weight % of a cyclic olefin copolymer.

14. The film of claim 1, wherein said sealant layer further comprises an ethylene or propylene polymer.

15. The film of claim 1, wherein said sealant layer comprises a plastomer or ionomer.

16. The film of claim 1, wherein said sealant layer further comprises linear low-density polyethylene, linear medium density polyethylene, low-density polyethylene, medium density polyethylene, ethylene vinyl acetate copolymer, ethylene methyl acrylate copolymer, ethylene methyl acrylic acid copolymer, or high density polyethylene.

17. The film of claim 1, wherein said film is a monolayer film comprising said sealant layer comprising a cyclic olefin copolymer.

18. The film of claim 1 comprising from 5 to 95 weight % of said sealant layer.

19. The film of claim 1 comprising from 10 to 90 weight % of said sealant layer.

20. The film of claim 1 comprising from 10 to 70 weight % of said sealant layer.

21. The film of claim 1 comprising from 15 to 40 weight % of said sealant layer.

22. The film of claim 1, wherein said film further comprises at least one additional layer.

23. The film of claim 1, wherein said film further comprises from 5 to 95 weight % of at least one additional layer.

24. The film of claim 1, wherein said film further comprises at least one additional layer comprising an ethylene or propylene polymer.

25. The film of claim 1, wherein said film further comprises at least one additional layer comprising linear low-density polyethylene, linear medium density polyethylene, low-density polyethylene, medium density polyethylene, ethylene vinyl acetate copolymer, ethylene methyl acrylate copolymer, ethylene methyl acrylic acid copolymer, or high density polyethylene.

26. The film of claim 1, wherein said film further comprises from 10-20 weight % of an additional layer.

27. The film of claim 1, wherein said film further comprises from 10-20 weight % of an additional layer comprising linear medium density polyethylene, high density polyethylene, or a polyolefin plastomer.

28. The film of claim 1, wherein said film further comprises from 12-75 weight % of an additional layer.

29. The film of claim 1 wherein said film further comprises from 12-75 weight % of an additional layer that is a print receivable layer.

30. The film of claim 1, wherein said film further comprises from 12-75 weight % of an additional layer comprising linear medium density polyethylene or high density polyethylene.

31. The film of claim 1, wherein said film further comprises from 5-15 weight % of an additional layer.

32. The film of claim 1, wherein said film further comprises from 5-15 weight % of an additional layer comprising an ethylene vinyl alcohol copolymer.

33. The film of claim 1, wherein said film further comprises from 5-15 weight % of an additional layer comprising nylon.

34. The film of claim 1, wherein said film further comprises from 4-12 weight % of an additional layer.

35. The film of claim 1, wherein said film further comprises from 4-12 weight % of a tie layer.

36. The film of claim 1, wherein said film further comprises from 4-12 weight % of an additional layer comprising an interpolymer adhesive.

37. The film of claim 1, wherein said film further comprises from 4-12 weight % of an additional tie layer.

38. The film of claim 1 further comprising:
a layer comprising a linear medium density polyethylene polymer;
a first tie layer;
a layer comprising an ethylene vinyl alcohol copolymer;
a second tie layer;
a layer comprising a linear medium density polyethylene polymer.

39. The film of claim 1 further comprising by weight of the total composition:
from 10-20 weight % of a layer comprising a linear medium density polyethylene polymer;
from 4-12 weight % of a layer comprising a first tie layer;
from 10-15 weight % of a layer comprising an ethylene vinyl alcohol copolymer;
from 4-12 weight % of a layer comprising a second tie layer;
from 12-75 weight % of a layer comprising a linear medium density polyethylene polymer.

40. The film of claim 1 further comprising:
a layer comprising a high density polyethylene polymer;
a layer comprising a first tie layer;
a layer comprising an ethylene vinyl alcohol copolymer polymer;
a layer comprising a second tie layer;
a layer comprising a high density polyethylene polymer.

41. The film of claim 1 further comprising:
from 10-20 weight % of a layer comprising a high density polyethylene polymer;
from 4-12 weight % of a layer comprising a first tie layer;
from 5-15 weight % of a layer comprising an ethylene vinyl alcohol copolymer;
from 4-12 weight % of a layer comprising a second tie layer;
from 12-75 weight % of a layer comprising a high density polyethylene polymer.

42. The film of claim 1 further comprising:
a layer comprising a high density polyethylene polymer;
a layer comprising a first tie layer;
a layer comprising a nylon resin;
a layer comprising a second tie layer;
a layer comprising a high density polyethylene polymer.

43. The film of claim 1 further comprising:
from 10-20 weight % of a layer comprising a high density polyethylene polymer;
from 4-12 weight % of a layer comprising a first tie layer;
from 5-15 weight % of a layer comprising a nylon resin;
from 4-12 weight % of a layer comprising a second tie layer;
from 12-75 weight % of a layer comprising a high density polyethylene polymer.

44. The film of claim 1 further comprising:
a layer comprising a polyolefin plastomer;
a layer comprising a high density polyethylene polymer.

45. The film of claim 1 further comprising by weight of the total composition:
from 10-20 weight % of a layer comprising a polyolefin plastomer;
from 12-75 weight % of a layer comprising a high density polyethylene polymer.

46. The film of claim 1, wherein said film comprises a blown film.

47. The film of claim 1, wherein said film comprises a cast film.

48. The film of claim 1 comprising from 10 to 40 weight % of said sealant layer and a cross directional Elmendorf tear/machine directional Elmendorf tear ratio of from 0.05 to 0.65.

49. The film of claim 1 comprising from 10 to 30 weight % of said sealant layer and a cross directional Elmendorf tear/machine directional Elmendorf tear ratio less than 0.20.

50. The film of claim 1 comprising from 10 to 25 weight % of said sealant layer and a cross directional Elmendorf tear/machine directional Elmendorf tear ratio less than 0.15.

51. The film of claim 1 comprising from 10 to 15 weight % of said sealant layer and a cross directional Elmendorf tear/machine directional Elmendorf tear ratio of less than 0.6.

52. The film of claim 1, wherein said tear is determine using Elmendorf tear testing.

53. The film of claim 1 laminated to a substrate.

54. The film of claim 53, wherein the substrate is a layer of polyester, polypropylene, biaxially oriented nylon, biaxially oriented polypropylene, or polyethylene.

55. The film of claim 53, laminated to the substrate by adhesive lamination, extrusion lamination, or thermal lamination.

56. The film of claim 1, further comprising surface or reverse printing.

57. A package comprising the film according to claim 1.

58. The package of claim 57, wherein said package is three sided.

59. The package of claim 57, wherein said package is four sided.

60. The package of claim 57, wherein said package is a pillow pouch.

61. The package of claim 57, wherein said package is a standup pouch.

62. The package of claim 57, wherein said package is a cross-directional tear package.

63. The package of claim 57 having a top seal, bottom seal, side seal, or fin seal.

64. The package of claim 57, wherein said package comprises a tear-start notch.

65. The package of claim 57, wherein said package comprises a hold and tear segment.

66. A method for producing a film according to claim 1, the method comprising forming a film comprising a sealant layer comprising a cyclic olefin copolymer.

67. The method of claim 66, wherein said method comprises blowing said film.

68. The method of claim 66, wherein said method comprises casting said film.
